(19) United States
(12) Patent Application Publication
(10) Pub. No.: US 2007/0103520 A1
(43) Pub. Date: May 10, 2007

(54) Interior pressure self-adjustable ink supply cartridge structure

(75) Inventor: Gwo Jyh Wu, Taichung City (TW)

Correspondence Address: TROXELL LAW OFFICE PLLC, SUITE 1404, 5205 LEESBURG PIKE, FALLS CHURCH, VA, 22041, US

(73) Assignee: U Colour International Co., Ltd.

(21) Appl. No.: 11/266,269

(22) Filed: Nov. 4, 2005

(51) Int. Cl. B41J 2/175

(52) U.S. Cl. 347/86

(57) ABSTRACT

An interior pressure self-adjustable ink supply cartridge structure comprises an ink container having an ink accommodating chamber and an adjacent first ink reservoir disposed at one inner side therein wherein a first linkage shallow channel is provided to connect the ink accommodating chamber and the first ink reservoir thereby, and a second linkage shallow channel is associated with the upper edge of the first ink reservoir thereof. A passageway is linked to the other end of the second linkage shallow channel and passed across to a first guide channel of a second ink reservoir disposed at the other inner side of the ink container therein. A second guide channel is disposed extending at the other side of the second ink reservoir to communicate with a continuous winding and shallow regulation duct to which a third guide channel is connected at the other end thereof to associate the regulation duct with a preset empty chamber having an air vent disposed at the upper edge thereon. Via the aforementioned structure thereof, no matter in what state the ink supply cartridge is, whether it's being delivered, opened for ink supply, or shutoff from ink supply thereof, the negative pressure established at the ink accommodating chamber therein can be appropriately maintained on a certain level, efficiently achieving an automatic self-adjustment of interior pressure of the ink supply cartridge so as to avoid the problem of ink leakage or the situation of abnormal ink supply thereby.

### BACKGROUND OF THE INVENTION

The present invention is related to an interior pressure self-adjustable ink supply cartridge structure, including an ink container having an ink accommodating chamber and an adjacent first ink reservoir disposed at one inner side therein wherein the ink accommodating chamber is connected to an ink outlet port to provide ink supply for use of a printer thereby, and when the ink stored therein is depleted, the ink container can be directly refilled via a set of first and second ink refilling ports to economically facilitate the reapplication of the ink supply cartridge thereby. Besides, via a regulation duct whose winding bends thereof can effectively prevent air from interacting with refluxed ink so as to avoid the problem of ink leakage and to omit any sticky paper applied onto an air vent for leak-proof purpose thereof.

There are basically three conventional types of ink supply cartridges for use of ink jet printers. First, there is an ink supply cartridge that has a porous material (e.g. foam cotton, etc.) accommodated therein to store ink thereby, and an air vent with an air channel opened thereon to maintain a smooth ink supply in application thereof as well as to avoid the problem of ink leakage thereby. However, with the porous material accommodated therein and to avoid the problem of ink leakage, the first conventional ink supply cartridge usually cannot take sufficient amount of ink therein. And, when the filled ink is consumed in part, the porous material without any ink stayed therein will take in outside air inside the ink supply cartridge, which can interfere with the regular supply of the filled ink and cause the problem of ink leftover. Besides, most of the porous material is made of foaming material and fibers, both of which, over long time of use, tend to produce tiny particles like short fibers to block the ink outlet port and get in the way of regular ink supply for use thereof.

A second type of the conventional ink supply cartridge includes an ink supply cartridge having a rear pressure adjustment device (like metallic tubes, or metallic balls, etc.) accommodated therein without any porous material applied thereto so that more ink can be filled into the ink supply cartridge thereof. However, it is really difficult to have a rear pressure adjustment device precisely and accurately made. First of all, the inner parts of the adjustment device thereof must be delicately processed, which, in terms of today's technology, is still to be improved and can boost the cost of production thereof. Besides, the rear pressure adjustment device thereof must be accurately mounted to the ink supply cartridge, which is quite complex in the process and can also increase the cost of processing thereof.

A third type of conventional ink supply cartridge is made up of an ink supply cartridge having a regulation apparatus accommodated therein wherein the regulation apparatus is usually made of an elastic air bag having an air vent disposed thereon to reciprocally communicate with the atmospheric air outside thereby. When the ink filled inside the cartridge is gradually consumed, outside air will enter the elastic air bag via the air vent thereof to inflate the volume of the elastic bag therewith. Depending on the consumption of the filled ink or the change of the atmospheric pressure of air outside, the volume of the elastic air bag will be changed within a certain range. And the change in the volume of the elastic air bag will in turn alter the volume of the ink accommodating space at the cartridge therein and regulate the negative pressure established at the cartridge therein so as to prevent the leakage of ink from the ink supply cartridge thereof. However, the third conventional ink supply cartridge has several disadvantages. Most of all, the biggest volume of the elastic air bag thereof is so limited that when the filled ink is consumed to a certain level, the elastic air bag will be inflated to its biggest volume and stop changing the volume of the ink accommodating space therewith. As a result, the continuous reduction of the filled ink will cause the negative pressure inside the ink cartridge to pass over the allowed limitation and make the ink droplets difficult to jet outwards. Therefore, the leftover ink will stay in the ink supply cartridge and uneconomically become a waste of the ink in application thereof.

Most of the conventional ink supply cartridges on the market comprise sticky papers applied onto air vents disposed thereon to regulate the interior pressure of the ink cartridges so as to avoid the reflux of ink in the process of delivery and, thus, the problem of ink leakage thereby. In case the sticky paper is not appropriately removed from the ink cartridge before application thereof, the air inside the ink cartridge will not interact with the ink and provide proper ink supply for use of the printer, which can easily damage the printer as well as the ink cartridge thereof. Besides, when the conventional ink supply cartridge is refilled with ink, the air inside the ink cartridge thereof must be drained outwards via ink refilling ports, which can bring out the refilled ink therewith and stain the ink refilling ports with ink marks. Thus, the conventional ink supply cartridge is quite inconvenient in application. Finally, the ink accommodating chambers of the conventional ink supply cartridges thereof are not appropriately designed according to the principles of relative density and space thereof, which can cause the problem of bad ink leakage when the ink supply cartridges are filled with ink to the full and installed onto printers for use thereof.

### SUMMARY OF THE PRESENT INVENTION

It is, therefore, the primary purpose of the present invention to provide an interior pressure self-adjustable ink supply cartridge structure wherein, when the ink supply cartridge is put upside down or laid flat in the process of delivery thereof and cause the ink stored therein to abnormally flow backwards, a set of first and second guide channels, a regulation duct, a third guide channel, and a preset empty chamber will sequentially form a buffer space, and the narrowed and winding bends of the regulation duct can prevent air from getting there-through to interact with the refluxed ink thereof so that the ink is simply allowed to retrace at the regulation duct therein, precisely avoiding the problem of ink leakage due to the refluxed ink in the process of application as well as delivery of the ink supply cartridge thereof.

It is, therefore, the second purpose of the present invention to provide an interior pressure self-adjustable ink supply cartridge structure wherein, in case of the reflux of the ink, the winding bends of the regulation duct can accurately prevent air from getting there-through and producing an interflow effect with the refluxed ink so as to avoid the problem of ink leakage thereby. And due to the narrowed and winding regulation duct to effectively prevent the ink from leaking outside the cartridge thereof, no other leak-proof sticky paper is required to be applied to an air vent of the ink supply cartridge or released there-from so as to avoid the damage caused by wrong operation thereof. Besides, the ink supply cartridge can be directly refilled with ink via a set of first and second ink refilling ports without being removed from a printer for the purpose thereof, economically facilitating an easy and fast application thereof.

It is, therefore, the third purpose of the present invention to provide an interior pressure self-adjustable ink supply cartridge structure wherein a first linkage shallow channel is provided to connect an ink accommodating chamber and a first ink reservoir of the ink supply cartridge so that, during the refilling process of the ink accommodating chamber and the first ink reservoir thereof, air taken inside the cartridge can be drained there-from via a second linkage shallow channel connected to the upper edge of the first ink reservoir and, thus, when the ink is being refilled via the second ink refilling port thereof, the refilled ink will not be brought outwards along with the refluxed air and cause untidy ink stains at the ink supply cartridge thereon. Besides, the ink supply cartridge can be directly refilled with ink via the first and second ink refilling ports without being removed from the printer thereof, achieving more convenient application thereof.

It is, therefore, the fourth purpose of the present invention to provide an interior pressure self-adjustable ink supply cartridge structure wherein the ink accommodating chamber of the ink supply cartridge is designed according to the volume of the ink container thereof and proportioned by the principles of relative density and space thereof so that when the ink accommodating chamber is refilled to the full and located onto a printer, the refilled ink will not leak out through an ink outlet port communicated with the ink accommodating chamber thereof.

It is, therefore, the fifth purpose of the present invention to provide an interior pressure self-adjustable ink supply cartridge structure wherein, when the ink supply cartridge is installed onto a printer for ink supply thereof, the second linkage shallow channel will form an air interflow channel inside the ink supply cartridge thereof, permitting outside air to enter the preset empty chamber through the air vent and travel in a series through the third guide channel, the regulation duct, the second guide channel, the second ink reservoir, and the first guide channel to go through a passageway and enter the first ink reservoir via the second linkage shallow channel thereof. When the air enters the second ink reservoir, the intake air will interact with the ink-pulling operation of the printer to produce a pull-and-push effect therewith, permitting the air inside the ink supply cartridge to be appropriately buffered and automatically regulated in pressure so as to maintain the negative pressure established at the ink supply cartridge therein on a certain level, efficiently avoiding the problem of ink leakage or the situation of abnormal ink supply thereof.

### BRIEF DESCRIPTION OF THE DRAWINGS

FIG. 1 is an assembled perspective view of the present invention.

FIG. 2 is an interior perspective view of one lateral side of the present invention.

FIG. 3 is an interior perspective view of another lateral side of the present invention.

FIG. 4 is a diagram showing a regulation of the interior pressure of the present invention.

FIG. 5 is another diagram showing a regulation of the interior pressure of the present invention.

### DETAILED DESCRIPTION OF THE PREFERRED EMBODIMENTS

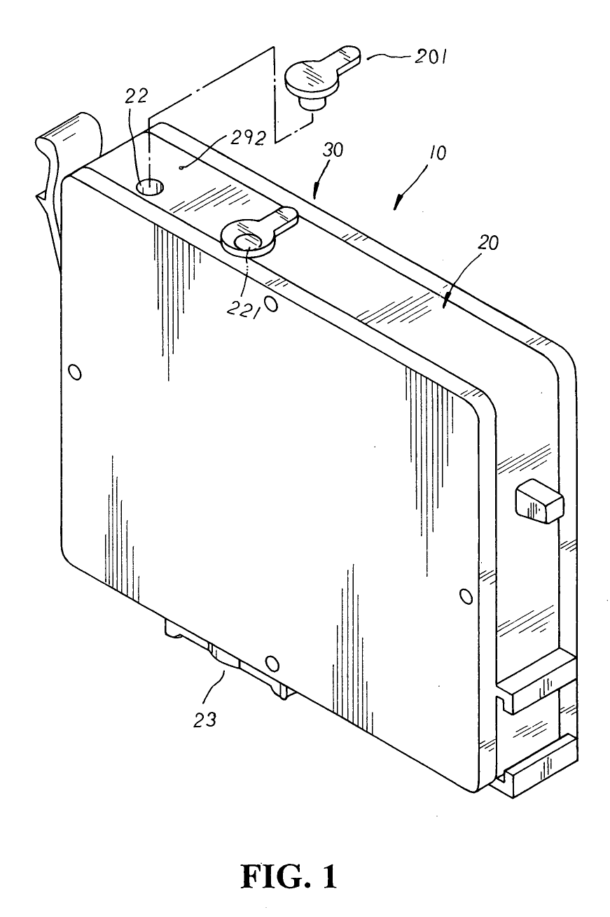

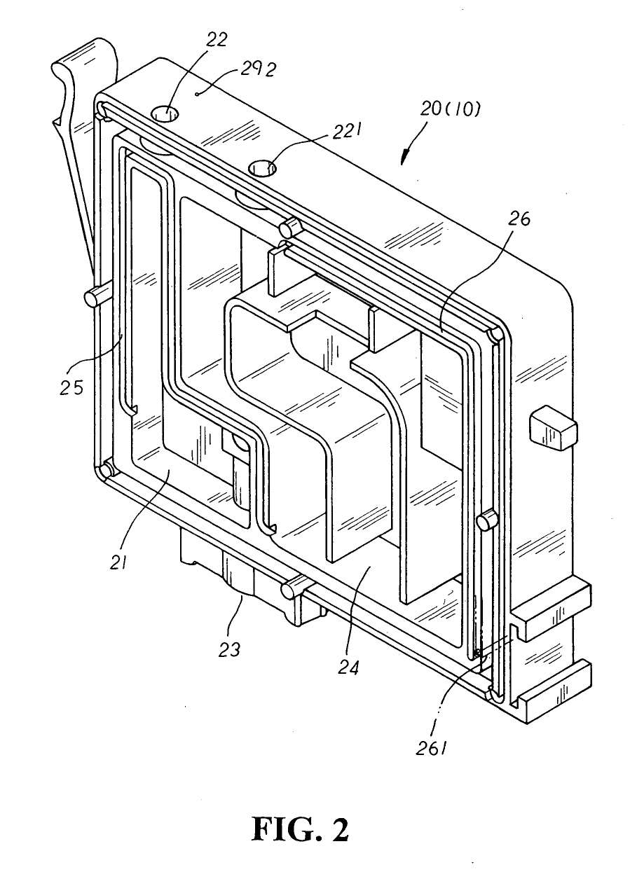

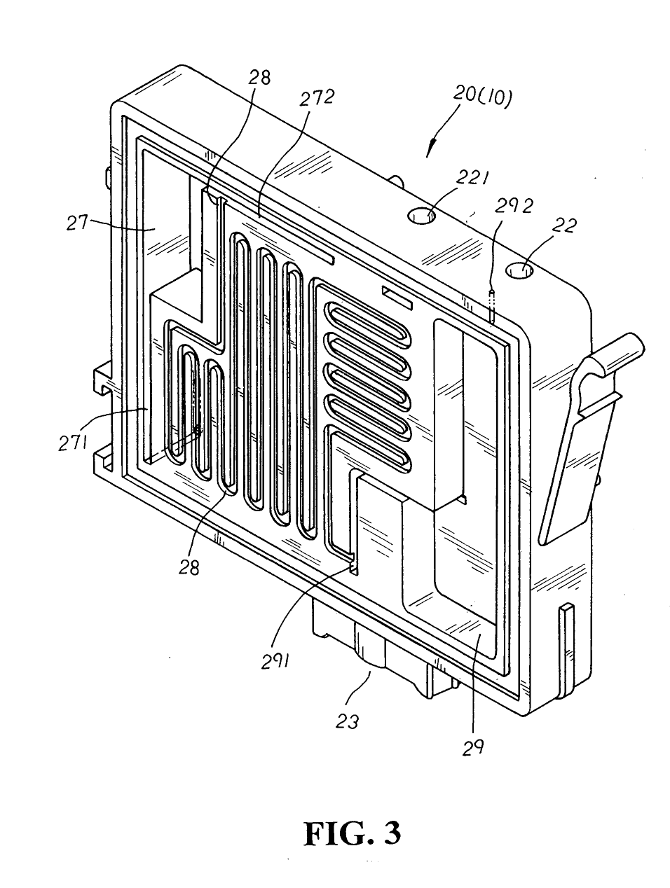

Please refer to FIG. 1 showing a perspective view of the present invention (accompanied by FIG. 2 showing an interior perspective view of one lateral side of the present invention). The present invention is related to an interior pressure self-adjustable ink supply cartridge structure, comprising an ink supply cartridge 10 made up of an ink container 20, and a thermal film 30 sealed off at one outer side of the ink container 20 wherein the ink container 20 has an ink accommodating chamber 21 of a proper depth appropriately indented one inner lateral side thereof and proportioned according to the principles of relative density and space thereof for the accommodation of ink therein. At the top and bottom sides of the ink container 20 is respectively disposed a first ink refilling port 22 and an ink outlet port 23 correspondingly communicated with the ink accommodating chamber 21 thereby wherein the ink outlet port 23 thereof is reciprocally associated with a non-illustrated ink supply needle of a print head for ink jet printing thereof. A first ink reservoir 24 is provided adjacent to the ink accommodating chamber 21 thereof and the first ink reservoir 24 having a depth deeper than that of the ink accommodating chamber 21 is communicated with a second ink refilling port 221 positioned adjacent to the first ink refilling port 22, both of which are respectively sealed off via a plug 201 after the completion of ink refilling operation thereof. A first linkage shallow channel 25 is connected with one lateral edge of the first accommodating chamber 21 and guided outside the first accommodating chamber 21 in an identical shape therewith; a second linkage shallow channel 26 is associated with one upper edge of the first ink reservoir 24 and extends in a right-angular form. Both ends of the first linkage shallow channel 25 are respectively communicated with the corresponding lower edges of the ink accommodating chamber 21 and the first ink reservoir 24 thereof, while the second linkage shallow channel 26, guided from the upper edge of the first ink reservoir 24 at one end, is led to an enclosed end at which a passageway 261 is disposed extending across to the other inner side of the ink container 20 so as to communicate the second linkage shallow channel 26 thereof with a first guide channel 271 connected to one side of a second ink reservoir 27 (referring to FIG. 3 showing a perspective view of another interior lateral side of the present invention). The second ink reservoir 27, having a depth protruding appropriately at a predetermined position at one side of the first ink reservoir 24, is provided with a second guide channel 272 extending at the other side thereof to associate with one end of a continuous winding and bending shallow regulation duct 28 thereby. A preset empty chamber 29 is situated at the other end of the regulation duct 28 and connected therewith via a right-angled third guide channel 291 thereby. At the upper edge of the preset empty chamber 29 is disposed an air vent 292 opening through the ink container 20 to communicate with the atmospheric air outside thereby.

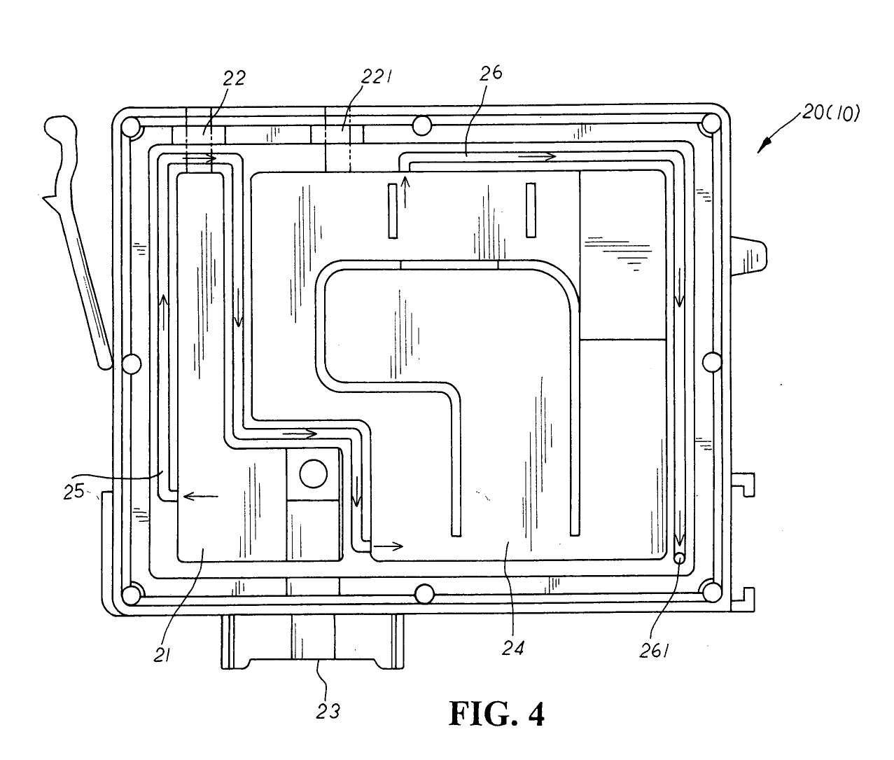

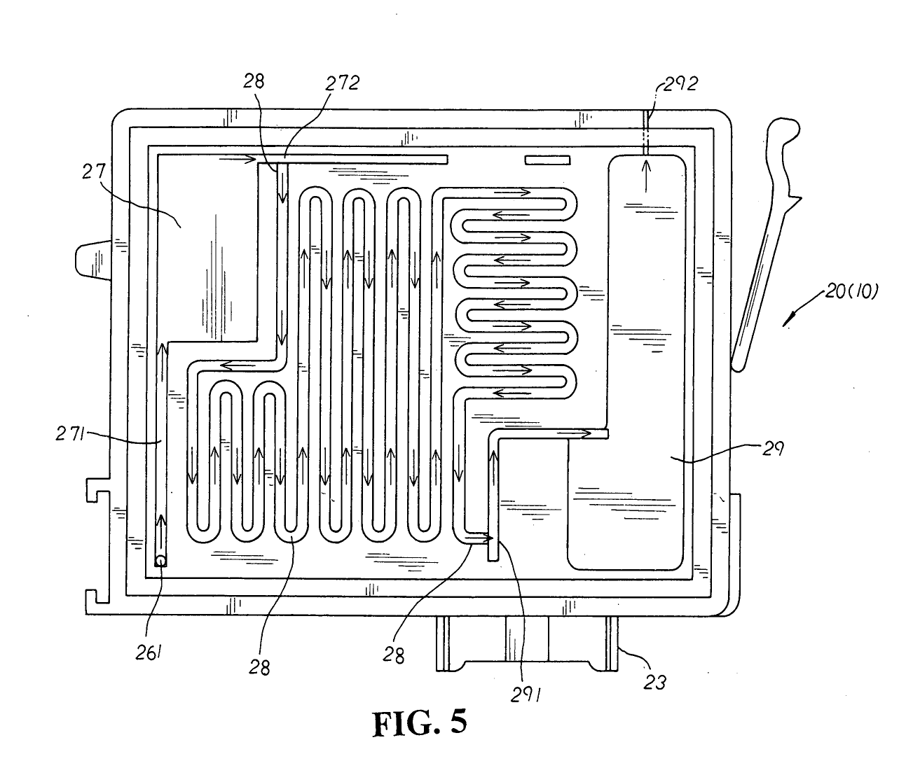

Please refer to FIGS. 4 to 5 inclusive showing a regulation of the interior pressure of the present invention. In application, the first and the second ink refilling ports 22, 221 are securely sealed off after the ink container 20 has finished with the filling of ink. When the ink supply cartridge 10 is put upside down or laid flat in the process of delivery thereof and causes the ink stored therein to abnormally flow backwards, the first and the second guide channels 271, 272, the regulation duct 28, and the third guide channel 291 along with the preset empty chamber 29 will sequentially form a buffer space so that the refluxed ink is simply allowed to retrace through the second linkage shallow channel 26 to go through the passageway 261 and enter the second ink reservoir 27 thereof. Because of the narrowed and winding bends of the regulation duct 28 thereof, air becomes difficult to get there-through to interact with the refluxed ink and generate an interflow effect therewith. Thus, the refluxed ink can only flow backwards to the second ink reservoir 27 and then stop therein without going further backwards to the third guide channel 291, let alone to the preset empty chamber 29 thereof, so as to accurately prevent the ink supply cartridge 10 from the problem of leakage caused by the ink reflux in the process of application or delivery thereof. Therefore, the ink supply cartridge 10 can be directly installed onto a printer for use without any leak-proof sticky paper being applied to seal off the air vent 292 thereof and then removed there-from, efficiently reducing the damage caused by wrong operation thereof and achieving an easier and speedier application thereof.

When the ink supply cartridge 10 is installed onto a printer for ink supply thereof, the second linkage shallow channel 26 will provide an air interflow channel inside the ink supply cartridge 10 thereof, permitting outside air to enter the preset empty chamber 29 through the air vent 292 and travel along in a series through the third guide channel 291, the regulation duct 28, the second guide channel 272, the second ink reservoir 27, and the first guide channel 271 to go through the passageway 261 and enter the first ink reservoir 24 through the second linkage shallow channel 26 thereof. When the air enters the second ink reservoir 27, the intake air will interact with the ink-pulling operation of the printer to produce a pull-and-push effect therewith. And the consecutive winding bends of the regulation duct 28 thereof can interfere with the travel of the intake air to provide a buffering effect thereby, limiting the intake air thereof to move therein at a proper speed—neither too fast nor too slow. Therefore, the air at the ink supply cartridge 10 therein is appropriately buffered and automatically regulated in pressure according to the demand of ink supply offered by the ink accommodating chamber 21 and the first ink reservoir 24 thereof so that the negative pressure established at the ink supply cartridge 10 therein can be maintained on a certain level to prevent the problem of ink leakage and ensure an accurate and normal ink supply in application thereof. Furthermore, in the state of ink supply, the ink stored inside the first ink reservoir 24, affected by the air pressure thereof, will first go through the first linkage shallow channel 25 and continuously flow into the ink accommodating chamber 21, and, when the ink inside the first ink reservoir 24 is completely depleted, the ink inside the ink accommodating chamber 21 will become gradually reduced.

When the ink stored inside both the ink accommodating chamber 21 and the first ink reservoir 24 is completely depleted, ink can be refilled therein via the first and the second ink refilling ports 22, 221 thereof. Meanwhile, the ink accommodating chamber 21 is connected with the first ink reservoir 24 via the first linkage shallow channel 25 so that, during the refilling process of the air accommodating chamber 21 and the first ink reservoir 24 thereof, air taken therein can be drained there-from via the second linkage shallow channel 26 thereof and, thus, when ink is refilled via the second refilling port 221 thereof, the refilled ink will not be brought outwards along with the refluxed air and cause the problem of untidy ink stains thereon. Besides, the ink supply cartridge 10 can be repeatedly refilled for economical reapplication without being disposed of, efficiently reducing the problem of environmental pollution.

Furthermore, the ink accommodating chamber 21 of the ink supply cartridge 10 is designed according to the volume of the ink container 20 and proportioned by the principles of relative density and space thereof so that when the ink accommodating chamber 21 thereof is refilled to the full and located onto the printer, the refilled ink will not leak out through the ink outlet port 23 thereof. And via the winding bends of the regulation duct 28 thereof, the ink supply cartridge 10 can normally function to provide accurate amount of ink for the printer and avoid the problem of ink leakage without any sponges applied therein for soaking ink thereby. In addition, the ink supply cartridge 10 can be easily refilled with ink via the first and the second ink refilling ports 22, 221 without being removed from the printer there-from, facilitating a more convenient application thereof.

What is claimed is:

1. An interior pressure self-adjustable ink supply cartridge structure, comprising an ink container having an ink accommodating chamber of a proper depth appropriately indented at one inner lateral side thereof for the accommodation of ink therein and in communication with a first ink refilling port and an ink outlet port disposed at the top and bottom sides of the ink container thereon respectively wherein the ink outlet port thereof is reciprocally associated with an ink supply needle of a print head for ink jet printing thereby; the present invention being characterized by that,
a first ink reservoir being provided adjacent to the ink accommodating chamber thereof and the first ink reservoir having a depth deeper than that of the ink accommodating chamber that is designed according to the volume of the ink container and proportioned by the principle of relative density and space thereof;
a second ink refilling port being positioned adjacent to the first ink refilling port in communication with the first ink reservoir thereof;
a first linkage shallow channel being disposed circumscribing in identical shape outside the first accommodating chamber, and a second linkage shallow channel being provided extending in right-angled shape at the upper edge of the first ink reservoir wherein both ends of the first linkage shallow channel are respectively communicated with the corresponding lower edges of the ink accommodating chamber and the first ink reservoir thereof, while the second linkage shallow channel, guided from the upper edge of the first ink reservoir, is led to an enclosed end at which a passageway is disposed extending across to the other inner side of the ink container so as to communicate the second linkage shallow channel thereof with a first guide channel connected to one side of a second ink reservoir;
the second ink reservoir, having a depth protruding appropriately at a predetermined position at one side of the first ink reservoir therein, being provided with a second guide channel extending at the other side thereof to associate with one end of a continuous winding and bending shallow regulation duct thereby;
a preset empty chamber being situated at the other end of the regulation duct and connected therewith via a right-angled third guide channel thereby, and at the upper edge of the preset empty chamber is disposed an air vent opened through the ink container to communicate with the atmospheric air outside thereby;
therefore, via the aforementioned structure, the ink supply cartridge with the ink accommodating chamber and the ink reservoirs disposed therein can efficiently provide ink supply for use of a printer, and when the ink stored inside is running out or depleted, the ink supply cartridge can be directly refilled with ink via the first and the second ink refilling ports thereof, facilitating economical reapplication of the ink supply cartridge thereof; besides, via the continuous winding bends of the regulation duct thereof, when the ink inside the cartridge abnormally flows backwards, the air won't get through the regulation duct and interact with the refluxed ink thereof, efficiently avoiding the problem of ink leakage thereby; and due to the regulation duct whose winding and bending structure thereof can effectively prevent the ink from leaking outside so that no leak-proof sticky paper is required to be applied onto the air vent thereof for the purpose thereof; in addition, the ink supply cartridge can be easily refilled with ink via the first and the second ink refilling ports without being removed from the printer thereof, facilitating a more convenient application thereof.
